(19) United States
(12) Patent Application Publication
(10) Pub. No.: US 2016/0098232 A1
(43) Pub. Date: Apr. 7, 2016

(54) IMAGE FORMING APPARATUS WITH SECURITY FUNCTION, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: Kei Sato, Kawasaki-shi (JP)

(21) Appl. No.: 14/865,699

(22) Filed: Sep. 25, 2015

(30) Foreign Application Priority Data
Oct. 7, 2014 (JP) 2014-206595

(51) Int. Cl. G06F 3/12; H04N 1/00; G06F 21/60

(52) U.S. Cl. CPC G06F 3/1222; G06F 21/608; H04N 1/00204; G06F 3/1238; G06F 3/1286; H04N 2201/3235

(57) ABSTRACT

An image forming apparatus that is capable of preventing occurrence of a security hole. A first receiving unit receives user information selected from a screen that is displayed by an operation unit of the image forming apparatus. A second receiving unit receives user information from an external apparatus via a network. An execution unit executes a login process based on user information received by the first or second receiving unit. A determination unit determines whether a password is set in the user information. A control unit restricts the login process based on the user information that is received by the second receiving unit and is determined that a password is not set.

### BACKGROUND OF THE INVENTION

1. Field of the Invention

The present invention relates to an image forming apparatus with a security function, a control method therefor, and a storage medium storing a control program therefor.

2. Description of the Related Art

There is a known conventional image forming apparatus equipped with an inherent user interface (hereinafter referred to as an “LUI (Local User Interface)”) (for example, see Japanese Laid-Open Patent Publication (Kokai) No. 2005-267201 (JP 2005-267201A)). A user inputs a user account that consists of an ID and a password into the image forming apparatus through the LUI, receives user authentication on the basis of the input user account, and uses the image forming apparatus concerned. There are two kinds of user authentication including general authentication and simple authentication. The general authentication requires an ID and a password at the time of authentication. The simple authentication omits to input a password and requires to input a user account that consists of a user ID only, or requires to touch a user's own icon displayed on a user interface, for example, in order to give a priority to user's convenience. Since the simple authentication does not require a password at the time of authentication, security deteriorates as compared with the general authentication.

Moreover, when a user instructs an image forming apparatus to execute printing from a PC that is connected to the image forming apparatus through a network, the user inputs a user account through a user interface (hereinafter referred to as an “RUI (Remote User Interface)”) of the PC, receives user authentication on the basis of the input user account, and uses the image forming apparatus. Unlike the LUI, since the RUI is provided on the PC as an external apparatus that is connected to the image forming apparatus and is easily accessible by a third party, the image forming apparatus needs to ensure high security at the time of user authentication through the RUI.

However, when the image forming apparatus performs the simple authentication through the RUI in order to give priority to user's convenience, high security cannot be ensured, which causes a problem of generating a security hole.

### SUMMARY OF THE INVENTION

The present invention provides an image forming apparatus, a control method therefor, and a storage medium storing a control program therefor, which are capable of preventing occurrence of a security hole.

Accordingly, a first aspect of the present invention provides an image forming apparatus comprising a first receiving unit configured to receive user information selected from a screen that is displayed by an operation unit of the image forming apparatus, a second receiving unit configured to receive user information from an external apparatus via a network, an execution unit configured to execute a login process based on user information received by one of the first receiving unit and second receiving unit, a determination unit configured to determine whether a password is set in the user information, and a control unit configured to restrict the login process based on the user information that is received by the second receiving unit and is determined that a password is not set.

Accordingly, a second aspect of the present invention provides a control method for an image forming apparatus comprising a first receiving step of receiving user information selected from a screen that is displayed by an operation unit of the image forming apparatus, a second receiving step of receiving user information from an external apparatus via a network, an execution step of executing a login process based on user information received in one of the first receiving step and the second receiving step, a determination step of determining whether a password is set in the user information, and a control step of restricting the login process based on the user information that is received by the second receiving unit and is determined that a password is not set.

Accordingly, a third aspect of the present invention provides a non-transitory computer-readable storage medium storing a control program causing a computer to execute the control method of the second aspect.

According to the present invention, occurrence of a security hole can be prevented.

Further features of the present invention will become apparent from the following description of exemplary embodiments with reference to the attached drawings.

### BRIEF DESCRIPTION OF THE DRAWINGS

FIG. 1 is a block diagram schematically showing a configuration of an image forming system including an image forming apparatus according to an embodiment of the present invention.

FIG. 2 is a block diagram schematically showing a hardware configuration of the image forming apparatus shown in FIG. 1.

FIG. 3 is a block diagram schematically showing a configuration of software executed by a CPU shown in FIG. 2.

FIG. 4 is a view showing an authentication setting screen displayed on an operation unit in FIG. 2.

FIG. 5 is a view showing an application selection screen displayed on the operation unit in FIG. 2.

FIG. 6 is a view showing a button login screen displayed on the operation unit in FIG. 2.

FIG. 7 is a view showing a user registration screen displayed on the operation unit in FIG. 2.

FIG. 8 is a flowchart showing procedures of an addition process executed by the CPU in FIG. 2.

FIG. 9 is a view showing an RUI authentication screen displayed on an operation-display unit of a PC in FIG. 1.

FIG. 10 is a view showing an error screen displayed when authentication information input through the RUI authentication screen in FIG. 9 does not coincide with authentication information stored in a user information storing module.

FIG. 11 is a view showing an LUI authentication screen displayed on the operation unit in FIG. 2.

FIG. 12 is a view showing an error screen displayed when authentication information input through the LUI authentication screen in FIG. 11 does not coincide with the authentication information stored in the user information storing module.

FIG. 13 is a flowchart showing procedures of an RUI user authentication process executed by the CPU in FIG. 2.

FIG. 14 is a flowchart showing procedures of an LUI button login process executed by the CPU in FIG. 2.

### DESCRIPTION OF THE EMBODIMENTS

Hereafter, embodiments according to the present invention will be described in detail with reference to the drawings.

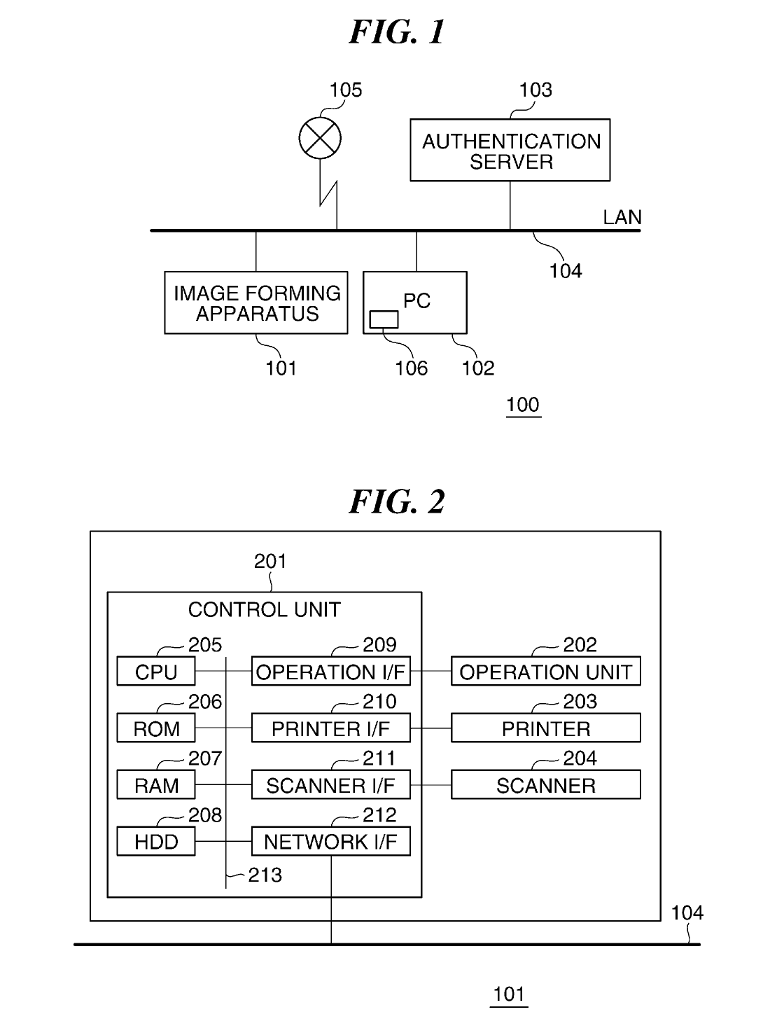

FIG. 1 is a block diagram schematically showing a configuration of an image forming system 100 including an image forming apparatus 101 according to an embodiment of the present invention.

The image forming system 100 in FIG. 1 is provided with the image forming apparatus 101, a PC 102, and an authentication server 103, and these components are mutually connected through a LAN 104. Moreover, the LAN 104 is connected to the Internet 105. The PC 102 communicates with the image forming apparatus 101 as an external apparatus of the image forming apparatus 101, and instructs execution of a print job through a printer driver (execution of a print job via a network). Moreover, the PC 102 has an operation-display unit 106 that functions as an RUI (Remote User Interface) of the image forming apparatus 101. The authentication server 103 has a database in which authentication information, such as a user account, is stored.

FIG. 2 is a block diagram schematically showing a hardware configuration of the image forming apparatus 101 shown in FIG. 1.

As shown in FIG. 2, the image forming apparatus 101 is provided with a control unit 201, an operation unit 202, a printer 203, and a scanner 204. The control unit 201 is provided with a CPU 205, a ROM 206, a RAM 207, an HDD 208, an operation I/F 209, a printer I/F 210, a scanner I/F 211, and a network I/F 212, and these components are mutually connected through a bus 213. Moreover, the operation unit 202, the printer 203, the scanner 204, and the LAN 104 are respectively connected to the operation I/F 209, the printer I/F 210, the scanner I/F 211, and the network I/F 212.

The operation unit 202 functions as an LUI (Local User Interface) of the image forming apparatus 101. Moreover, the operation unit 202 is provided with hard keys, an operation panel, etc. A user inputs an instruction and information into the image forming apparatus 101 through the hard keys and the operation panel. It should be noted that the operation panel has a liquid crystal display monitor that displays information about the image forming apparatus 101. The printer 203 prints image data obtained by the scanner 204 onto a recording sheet, for example. The scanner 204 reads an original, and generates image data. The CPU 205 runs programs stored in the ROM 302 to execute various control processes. The RAM 207 is a work memory for the CPU 205. The HDD 208 stores image data and various programs.

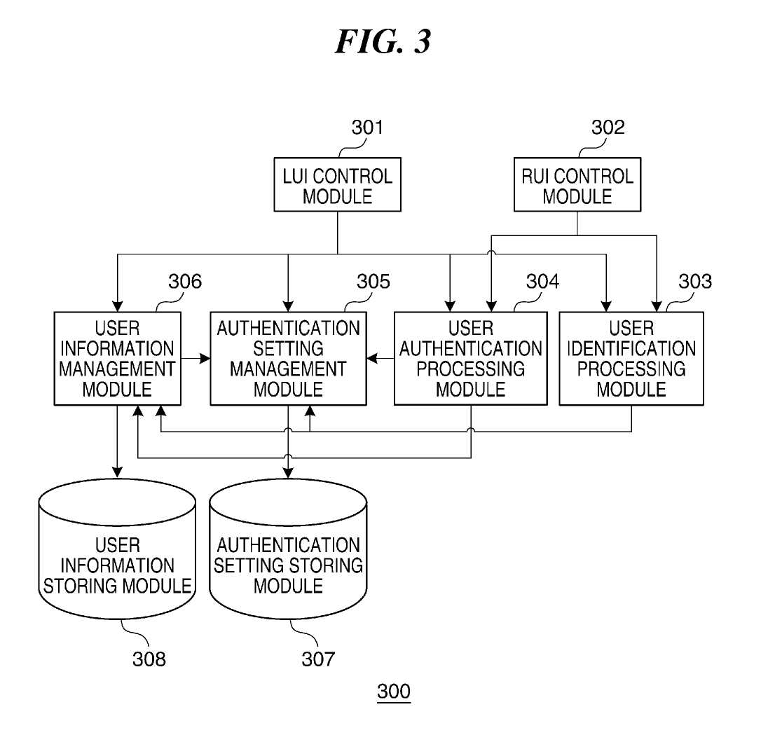

FIG. 3 is a block diagram schematically showing a configuration of software 300 executed by the CPU 205 shown in FIG. 2.

The software 300 is provided with an LUI control module 301, an RUI control module 302, a user identification processing module 303, a user authentication processing module 304, an authentication setting management module 305, a user information management module 306, an authentication setting storing module 307, and a user information storing module 308.

The LUI control module 301 controls the operation unit 202, and transmits the information that the user inputs through the operation unit 202 to the modules, such as the user authentication processing module 304 and the user information management module 306. Moreover, the LUI control module 301 displays the information received from the modules on the operation unit 202.

The RUI control module 302 displays a web page on the operation-display unit 106 of the PC 102. The RUI control module 302 transmits the information that the user input through the web page to the user identification processing module 303 and the user authentication processing module 304. Moreover, the RUI control module 302 displays the information received from the modules on a web page.

The user identification processing module 303 identifies the user who uses the image forming apparatus 101. The user authentication processing module 304 executes user authentication on the basis of the authentication information that the user inputs through the LUI or the RUI and the authentication information stored in the user information storing module 308.

The authentication setting management module 305 manages the setup information about the user authentication stored in the authentication setting storing module 307, which is a part of the HDD 208. The setup information about the user authentication is set in an authentication setting screen 400.

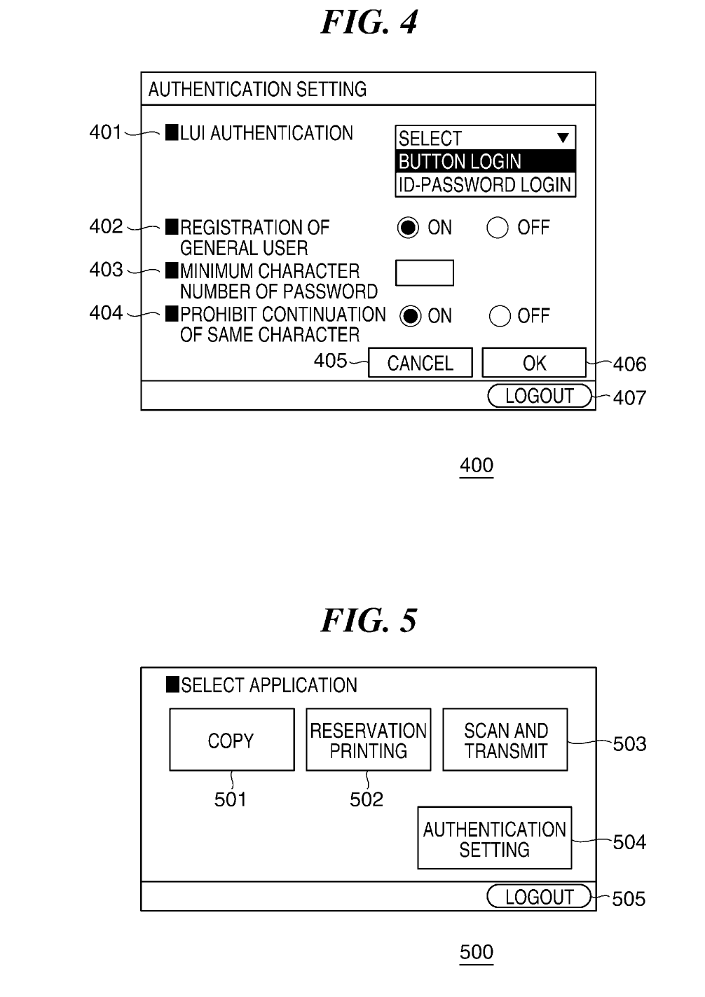

FIG. 4 is a view showing the authentication setting screen 400 displayed on the operation unit 202 in FIG. 2. The authentication setting screen 400 in FIG. 4 is operated by the user who received user authentication, for example, an administrator.

The authentication setting screen 400 has setting items 401 through 404 according to information about various settings, a cancel button 405, an OK button 406, and a logout button 407. An authentication method by which the image forming apparatus 101 receives the user authentication through the LUI is set in the setting item 401. There are two kinds of authentication methods including button login and ID-password login. One of them that is selected by the user is set as the authentication method.

Here, the button login is an authentication method by which user authentication is received when a user touches a user's own icon displayed on the LUI. It is one of simple authentications that do not require a password at the time of user authentication. The ID-password login is an authentication method by which user authentication is received when a user inputs an ID and a password. It is one of general authentications that require a password at the time of user authentication.

Information about whether an addition (registration) of a general user (mentioned below) is allowed as a user who uses the image forming apparatus 101 is set in the setting item 402. Password policies that a password used at the time of user authentication should satisfy are set to the setting items 403 and 404. In detail, the minimum character number of a password used at the time of user authentication is set to the setting item 403. Information about whether continuation of the same character in a password used at the time of user authentication is prohibited is set to the setting item 404.

The cancel button 405 is pressed when a user cancels the settings in the setting items 401 through 404. The OK button 406 is pressed when a user fixes the settings in the setting items 401 through 404. The logout button 407 is pressed when a user who operates the authentication setting screen 400 finishes the operation and logs out.

When the cancel button 405 or the OK button 406 is pressed, an application selection screen 500 (FIG. 5) is displayed on the operation unit 202. The application selection screen 500 has a copy button 501, a reservation printing button 502, a scan button 503, an authentication setting button 504, and a logout button 505.

When the copy button 501, the reservation printing button 502, or the scan button 503 is pressed, an application screen (not shown) corresponding to the pressed button is displayed. For example, when the copy button 501 is pressed, the user operates the displayed application screen to print image data read with the scanner 204 on a recording sheet with the printer 203. Moreover, when the reservation printing button 502 is pressed, the image forming apparatus 101 stores print data received from the PC 102 in the HDD 208, and prints the stored print data in response to a user's operation on the operation unit 202. Furthermore, when the scan button 503 is pressed, the characters etc. on an original are read and image data is generated.

When the authentication setting button 504 is pressed, the authentication setting screen 400 is displayed on the operation unit 202. The logout button 505 is pressed when the user who operates the application selection screen 500 finishes the operation and logs out.

Referring back to FIG. 3, the user information management module 306 manages user's authentication information stored in the user information storing module 308, which is a part of the HDD 208. The user's authentication information (user information) consists of a user name, a password, and a role, for example. The role indicates a group to which each user belongs when a plurality of users are divided into a plurality of groups. There are an administrator group to which administrators belong and a general user group to which general users belong, for example, as groups to which users belong.

A general user does not have a permission to set up the setting information about the user authentication, for example. Moreover, although a general user is allowed to use the image forming apparatus 101, the usable functions of the image forming apparatus 101 may be restricted by an administrator. An administrator has the permission to set up the setting information about the user authentication, for example, and can restrict the functions of the image forming apparatus 101 that a general user can use. Accordingly, a security level of the image forming apparatus 101 needed for a general user is lower than a security level of the image forming apparatus 101 needed for an administrator.

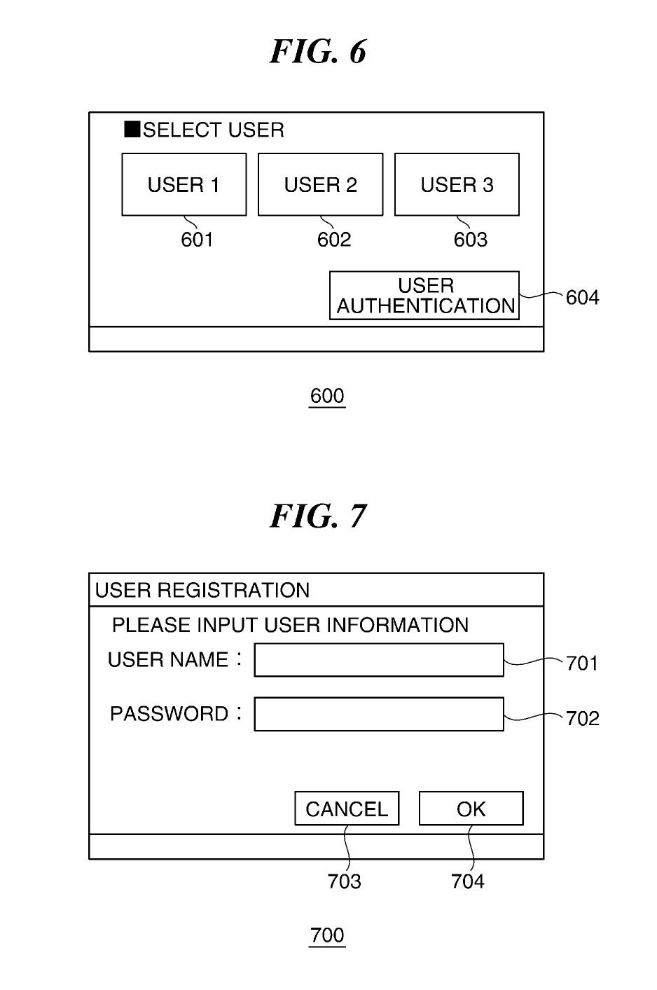

FIG. 6 is a view showing a button login screen 600 displayed on the operation unit 202 in FIG. 2. The button login screen 600 in FIG. 6 is displayed when button login is selected in the setting item 401 and the button login is performed through the operation unit 202.

The button login screen 600 has user buttons 601 through 603 and a user registration button 604. Each of the user buttons 601 through 603 is associated with user's authentication information stored in the user information storing module 308. For example, when a certain user presses the user button 601 (login request), the certain user receives user authentication on the basis of user's authentication information associated with the user button 601 (response to the login request). The user registration button 604 is pressed when a user different from the users associated with the user buttons 601 through 603 receives authentication from the image forming apparatus 101. When the user registration button 604 is pressed, a user registration screen 700 (FIG. 7) is displayed on the operation unit 202.

The user registration screen 700 in FIG. 7 has input columns 701, 702, a cancel button 703, and an OK button 704.

A user name used in the user authentication is entered in the input column 701, and a password used in the user authentication is entered in the input column 702. When the button login is selected in the setting item 401 at this time, it is not necessary to input anything into the input column 702 (input of a null character string). The cancel button 703 is pressed when the user cancels the addition (registration) of a user. The OK button 704 is pressed when the user adds (registers) a user with the user name and password that are entered in the input columns 701 and 702.

When the ID-password login is set up in the setting item 401, it becomes indispensable to enter a password that consists of a character string to the input column 702. Furthermore, when the password policy is set up in at least one of the setting items 403 and 404, the password entered into the input column 702 is required to satisfy the password policy (policies).

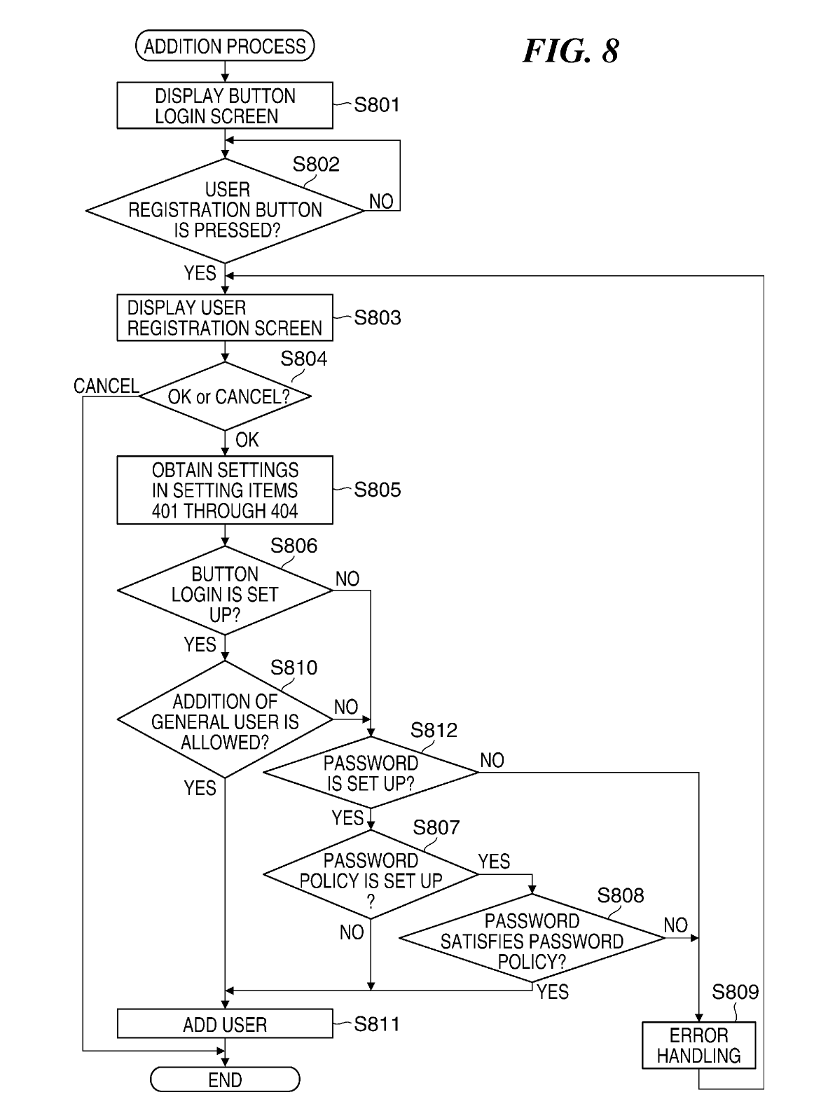

FIG. 8 is a flowchart showing procedures of an addition process executed by the CPU 205 shown in FIG. 2.

As shown in FIG. 8, the button login screen 600 is displayed on the LUI first (step S801), and it is determined whether the user registration button 604 is pressed (step S802). As a result of the determination in the step S802, when the user registration button 604 is not pressed, the process in the step S802 is repeated. When the user registration button 604 is pressed, the user registration screen 700 is displayed on the LUI (step S803). A user enters a user name in the input column 701 in the user registration screen 700, and enters a password into the input column 702 if needed. Next, it is determined whether the OK button 704 is pressed under a condition where a user name is entered in the input column 701 at least or the cancel button 703 is pressed (step S804).

As a result of the determination in the step S804, when the cancel button 703 is pressed, this process finishes. On the other hand, when the OK button 704 is pressed, the settings in the setting items 401 through 404 are obtained (step S805), and it is determined whether the button login is selected with reference to the setting in the setting item 401 (step S806). As a result of the determination in the step S806, when the button login is not selected, it is determined whether a password that consists of a character string is entered in the input column 702 (step S812). As a result of the determination in the step S812, the password is entered, it is determined whether at least one password policy is set up with reference to the settings in the setting items 403 and 404 (step S807).

As a result of the determination in the step S807, when no password policy is set up, the user is added (step S811) and this process finishes. On the other hand, when at least one password policy is set up, it is determined whether the password entered in the input column 702 satisfies the password policies/policy set up in the setting items 403 and/or 404 (step S808). As a result of the determination in the step S808, when the password policies/policy are/is satisfied, the user is added (step S811) and this process finishes. When a password is not entered as a result of the determination in the step S812, or when the password does not satisfy the password policies/policy as a result of the determination in the step S808, an error handling is executed without adding a user (step S809) and the process returns to the step S803.

As a result of the determination in the step S806, when the button login is selected, it is determined whether the addition of a general user is allowed on the basis of the setting item 402 (step S810). As a result of the determination in the step S810, when the addition of a general user is allowed, the user is added (step S811) and this process finishes. When the addition of a general user is not allowed (i.e., when the addition of an administrator is only allowed), the process proceeds to the step S812. The process after the step S812 is as mentioned above.

According to the process in FIG. 8, when the addition of an administrator is allowed, even if the button login that is a simple authentication is accepted, it is required to enter a password consisting of a character string in the input column 702 (step S812). Accordingly, since coincidence in the password is required in addition to coincidence in the user name when an administrator uses the image forming apparatus 101, a high security level can be ensured in the image forming apparatus 101.

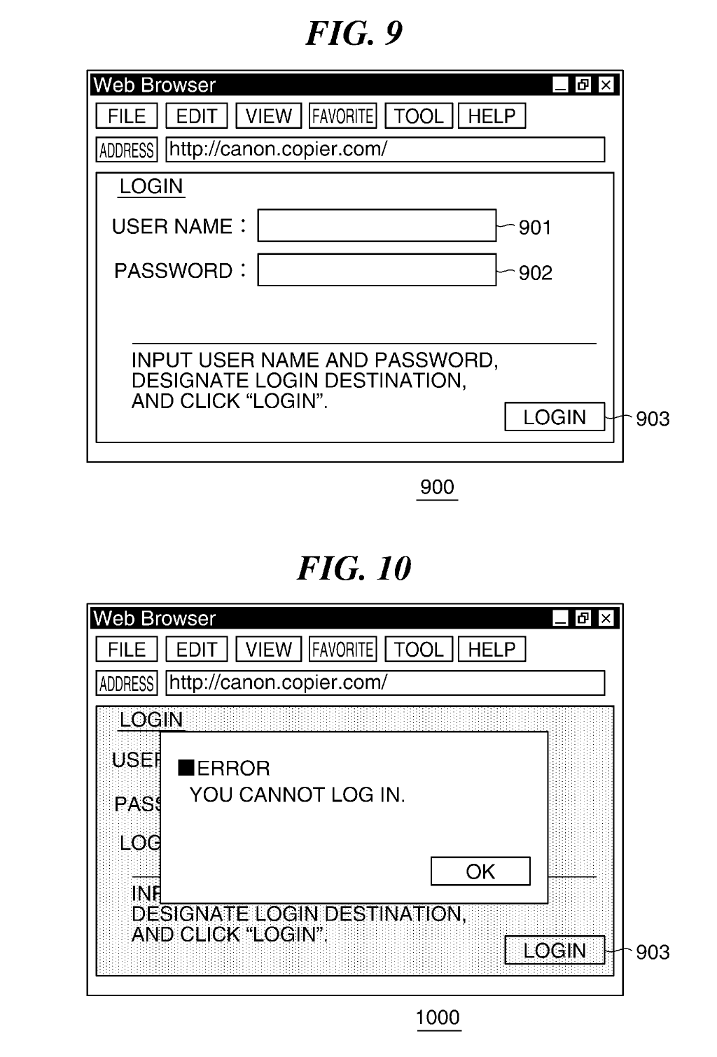

FIG. 9 is a view showing an RUI authentication screen 900 displayed on the operation-display unit 106 of the PC 102 in FIG. 1.

The RUI authentication screen 900 in FIG. 9 is used when the ID-password login is executed through the operation-display unit 106 of the PC 102 that functions as the RUI of the image forming apparatus 101. The RUI authentication screen 900 has input columns 901 and 902, and a login button 903. A user enters a user name and a password in the input columns 901 and 902, respectively, and presses the login button 903.

When the input information entered in the input columns 901 and 902 (information identifying a user) at the time of pressing the login button 903 is coincident with the authentication information stored in the user information storing module 308, the user receives the user authentication of the image forming apparatus 101. If the input information entered into the input columns 901 and 902 is not coincident with the authentication information stored in the user information storing module 308, an error screen 1000 (FIG. 10) is displayed.

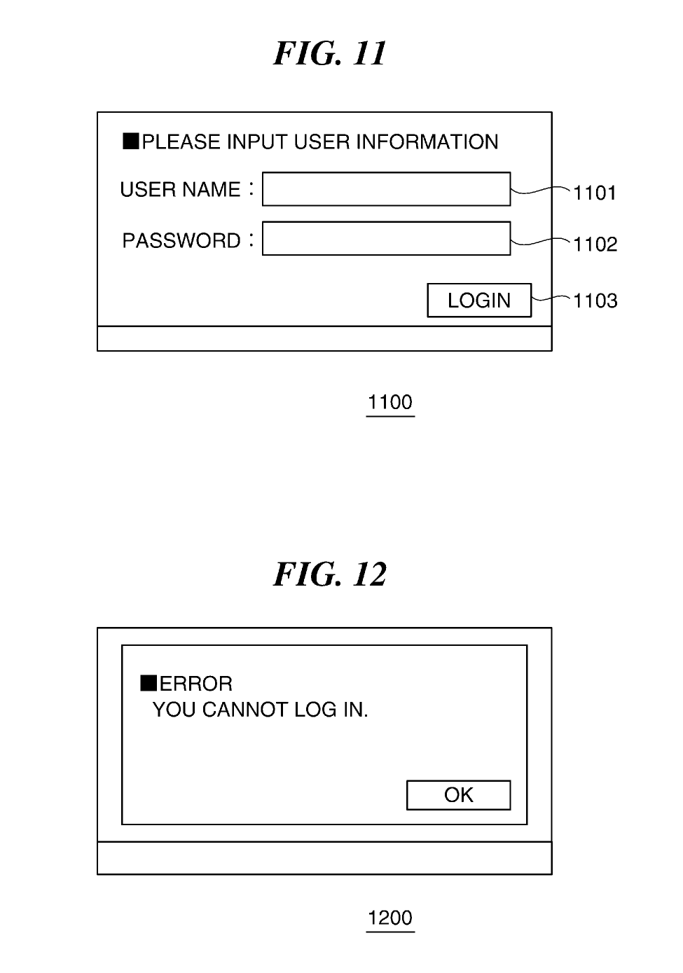

FIG. 11 is a view showing an LUI authentication screen 1100 displayed on the operation unit 202 in FIG. 2.

The LUI authentication screen 1100 in FIG. 11 is used when the ID-password login is executed through the operation unit 202 that functions as the LUI of the image forming apparatus 101. The LUI authentication screen 1100 has input columns 901 and 902, and a login button 1103. A user enters a user name and a password (input information) in the input columns 1101 and 1102, and presses the login button 1103.

When the input information entered in the input columns 1101 and 1102 at the time of pressing the login button 1103 is coincident with the authentication information stored in the user information storing module 308, the user receives the user authentication of the image forming apparatus 101. If the input information entered into the input columns 1101 and 1102 is not coincident with the authentication information stored in the user information storing module 308, an error screen 1200 (FIG. 12) is displayed.

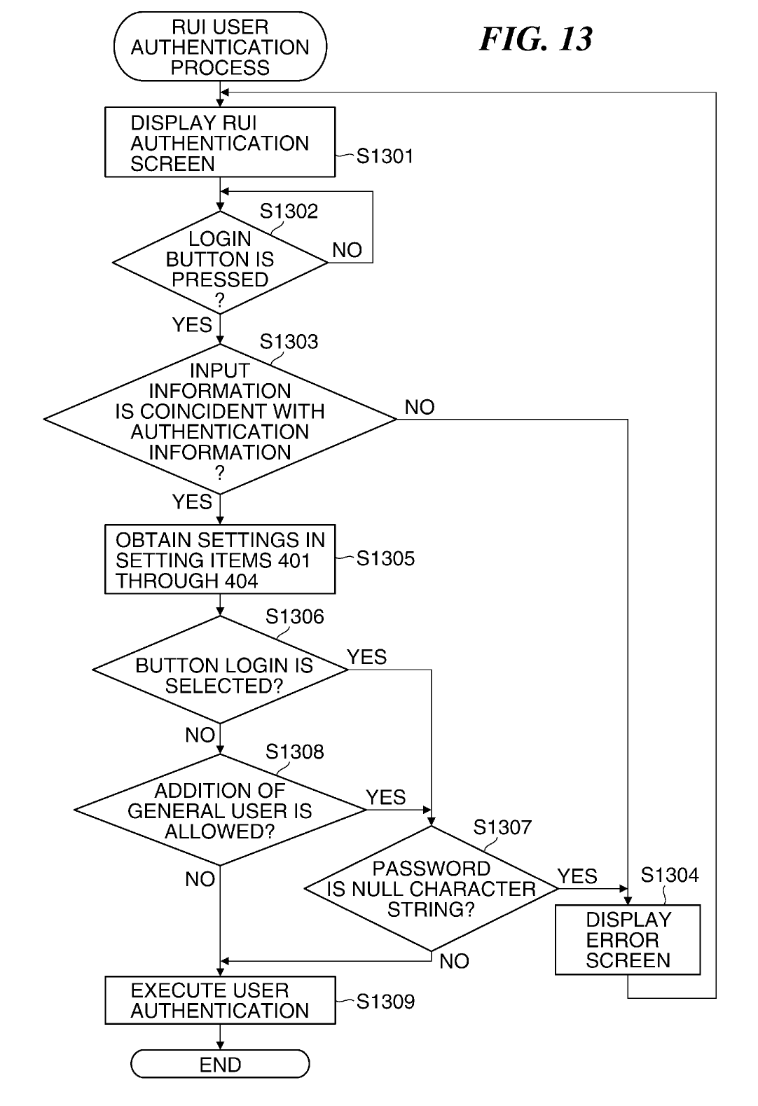

FIG. 13 is a flowchart showing procedures of an RUI user addition process executed by the CPU 205 shown in FIG. 2.

In FIG. 13, the CPU 205 first displays the RUI authentication screen 900 on the RUI (the operation-display unit 106) (step S1301). A user enters a user name and a password (input information) in the input columns 901 and 902, and presses the login button 903. The CPU 205 determines whether the login button 903 is pressed (step S1302). As a result of the determination in the step S1302, when the login button 903 is not pressed, the process in the step S1302 is repeated. When the login button 903 is pressed, it is determined whether the input information entered in the input columns 901 and 902 is coincident with the authentication information stored in the user information storing module 308 (step S1303).

As a result of the determination in the step S1303, when the input information is not coincident with the authentication information, the error screen 1000 is displayed on the RUI (step S1304) and the process returns to the step S1301. When the input information is coincident with the authentication information, the settings in the setting items 401 through 404 are obtained (step S1305), and it is determined whether the button login is selected with reference to the setting in the setting item 401 (step S1306).

As a result of the determination in the step S1306, when the button login is selected, it is determined whether the password entered in the input column 902 is a null character string (step S1307). As a result of the determination in the step S1307, when the password entered in the input column 902 is a null character string, the error screen 1000 is displayed on the RUI (step S1304) and the process returns to the step S1301. When the password entered in the input column 902 is not a null character string (NO in the step S1307), the user authentication is executed (step S1309), and this process finishes.

As a result of the determination in the step S1306, when the button login is not selected, it is determined whether an addition of a general user is allowed with reference to the setting in the setting item 402 (step S1308). As a result of the determination in the step S1308, when an addition of a general user is allowed, the process proceeds to the step S1307. The process after the step S1307 is as mentioned above. On the other hand, when an addition of a general user is not allowed, the user authentication is executed (step S1309) and this process finishes. It should be noted that the application selection screen 500 is displayed on the RUI when the user authentication is executed in the step S1309.

According to the process in FIG. 13, when the button login is selected in the setting item 401 (YES in the step S1306), and when the password entered in the input column 902 is a null character string (YES in the step S1307), the error screen 1000 is displayed on the RUI (the step S1304) without executing the user authentication. This prevents the button login with low security through the RUI, and ensures high security in the image forming apparatus 101, which enables to prevent occurrence of a security hole.

Moreover, when the button login is not selected (NO in the step S1306), when an addition of a general user is allowed (YES in the step S1308), and when the password entered in the input column 902 is a null character string (YES in the step S1307), the error screen 1000 is displayed on the RUI (the step S1304) without executing the user authentication. Accordingly, the general authentication is not executed to the general user whose password is a null character string. This prevents execution of the general authentication to a user with a low security level (a general user whose password is a null character string).

It should be noted that FIG. 13 describes the case where the error screen 1000 is displayed on the RUI and the user is not authenticated when the user with a low security level tries login through the RUI. Against this, when a user with a low security level tries login through the RUI, the user may be authenticated without displaying the error screen 1000 on the RUI while restricting the functions of the image forming apparatus 101 that can be used by the user concerned. Moreover, whether the user concerned is authenticated may be determined on the basis of the role in the user's authentication information stored in the user information storing module 308. This also enables to ensure the security in the image forming apparatus 101.

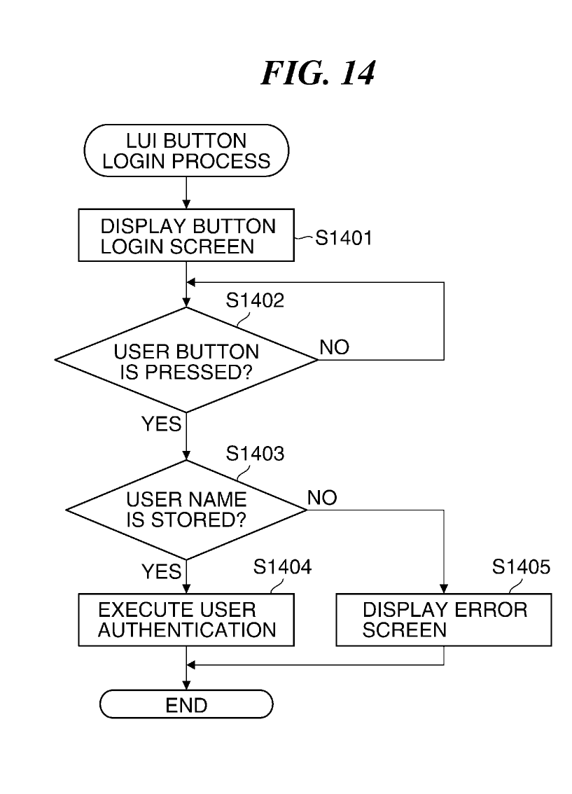

FIG. 14 is a flowchart showing procedures of an LUI button login process executed by the CPU 205 shown in FIG. 2.

As shown in FIG. 14, the button login screen 600 is displayed on the LUI first (step S1401), and it is determined whether one of the user buttons 601 through 603 is pressed (step S1402). As a result of the determination in the step S1402, when none of the user buttons 601 through 603 is pressed, the process in the step S1402 is repeated. When one of the user buttons 601 through 603 is pressed, it is determined whether the user name corresponding to the pressed user button is stored in the user information storing module 308 (step S1403).

As a result of the determination in the step S1403, when the user name corresponding to the pressed user button is stored in the user information storing module 308, the user authentication is executed (step S1404) and this process finishes. When the user name corresponding to the pressed user button is not stored in the user information storing module 308, the error screen 1200 is displayed (step S1405) and this process finishes. It should be noted that the application selection screen 500 is displayed on the LUI when the user authentication is executed in the step S1404.

According to the process in FIG. 14, when one of the user buttons 601 through 603 is pressed through the LUI (YES in the step S1402), the button login is executed, which ensures user's convenience.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-206595, filed Oct. 7, 2014, which is hereby incorporated by reference herein in its entirety.

What is claimed is:

1. An image forming apparatus comprising:
a first receiving unit configured to receive user information selected from a screen that is displayed by an operation unit of the image forming apparatus;
a second receiving unit configured to receive user information from an external apparatus via a network;
an execution unit configured to execute a login process based on user information received by one of said first receiving unit and second receiving unit;
a determination unit configured to determine whether a password is set in the user information; and
a control unit configured to restrict the login process based on the user information that is received by said second receiving unit and is determined that a password is not set.

2. The image forming apparatus according to claim 1, further comprising an execution unit configured to execute user authentication that does not require a password is requested as the user authentication.

3. The image forming apparatus according to claim 2, further comprising an addition unit configured to add user information about a user who uses the image forming apparatus,
wherein said addition unit comprises a setting unit that sets up a password consisting of a character string or a null character string to the user information when said addition unit adds the user information,
wherein said execution unit executes a general authentication that requires a password to the user corresponding to the password consisting of the character string as the user authentication when the password consisting of the character string is set up, and
wherein said execution unit does not execute the general authentication to the user corresponding to the password consisting of the null character string when the password consisting of the null character string is set up.

4. The image forming apparatus according to claim 3, wherein users includes a general user and an administrator who needs security level higher than security level required for the general user, and
wherein said setting unit sets up a password consisting of a character string as the password when a user is the administrator, and sets up a password consisting of the null character string as the password when a user is the general user.

5. The image forming apparatus according to claim 4, wherein a password policy is set to the password consisting of the character strings.

6. A control method for an image forming apparatus comprising:
a first receiving step of receiving user information selected from a screen that is displayed by an operation unit of the image forming apparatus;
a second receiving step of receiving user information from an external apparatus via a network;
an execution step of executing a login process based on user information received in one of said first receiving step and said second receiving step;
a determination step of determining whether a password is set in the user information; and
a control step of restricting the login process based on the user information that is received by said second receiving unit and is determined that a password is not set.

7. A non-transitory computer-readable storage medium storing a control program causing a computer to execute a control method for an image forming apparatus, the control method comprising:
a first receiving step of receiving user information selected from a screen that is displayed by an operation unit of the image forming apparatus;
a second receiving step of receiving user information from an external apparatus via a network;
an execution step of executing a login process based on user information received in one of said first receiving step and said second receiving step;
a determination step of determining whether a password is set in the user information; and
a control step of restricting the login process based on the user information that is received by said second receiving unit and is determined that a password is not set.
